(19) United States
(12) Patent Application Publication
(10) Pub. No.: US 2024/0373413 A1
(43) Pub. Date: Nov. 7, 2024

(54) METHOD FOR FACILITATING REFERENCE SIGNAL COMMUNICATION IN A WIRELESS SYSTEM

(71) Applicant: Sony Group Corporation, Tokyo (JP)

(72) Inventor: Johan HILL, Lund (SE)

(21) Appl. No.: 18/684,740

(22) PCT Filed: Aug. 16, 2022
(86) PCT No.: PCT/EP2022/072816

§ 371 Date: Feb. 19, 2024

(30) Foreign Application Priority Data
Sep. 21, 2021 (SE) 2151146-4

(51) Int. Cl. H04W 72/0457; H04L 5/00; H04W 72/0446; H04W 72/51

(52) U.S. Cl. CPC H04W 72/0457; H04L 5/0051; H04W 72/0446; H04W 72/51

(57) ABSTRACT

A method, carried out in a wireless network (100) comprising access nodes, for configuring a user equipment, UE, (10) for communication of reference signals (161, 162, 163) between the UE and the wireless network, the method comprising: transmitting (402, 703) resource allocation information to the UE, associated with a first bandwidth part, BWP, (aBWP) for data communication; transmitting (404, 801), in resources of the first BWP, a control message (64) controlling the UE to transmit or receive said reference signals in a configured (705) second BWP (pBWP), wherein the second BWP is different from the first BWP.

### TECHNICAL FIELD

This disclosure is related to wireless communication between a wireless device and a wireless network of a wireless system, such as one or more access node of the wireless network. Specifically, solutions are provided for facilitating configuration of a channel for communicating reference signals to reduce latency in operations dependent on such reference signals, such as positioning.

### BACKGROUND

Various protocols and technical requirements for wireless communication have been standardized under supervision of inter alia the 3^{rd} Generation Partnership Project (3GPP). Improvement and further development are continuously carried out, and new or amended functions and features are thus implemented in successive releases of the technical specifications providing the framework for wireless communication.

Wireless communication may in various scenarios be carried out between a wireless network and a wireless device. The wireless network typically comprises an access network including a plurality of access nodes, which historically have been referred to as base stations. In a 5G radio access network such a base station may be referred to as a gNB. Each access node may be configured to serve one or more cells of a cellular wireless network. A variety of different types of wireless devices may be configured to communicate with the access network, and such wireless devices are generally referred to as User Equipment (UE). Communication which involves transmission from the UE and reception in the wireless network is generally referred to as Uplink (UL) communication, whereas communication which involves transmission from the wireless network and reception in the UE is generally referred to as Downlink (DL) communication.

Communication in a wireless system may involve sending data in the UL and/or DL for conveying information. Moreover, control signaling is carried out for different purposes, such as for setting up or reconfiguring data channels. Apart from communication of data, different nodes of the wireless system, including access nodes and UEs, may be configured to transmit reference signals for various purposes, such as for measurement by other nodes in the wireless system. Various examples of such reference signals may be usable for location services, predominantly for positioning of a UE.

In some configurations, communication between a UE and an access node of the wireless network may allocated to a certain frequency segment referred to as a bandwidth part (BWP). For certain operations, which require or rely on the communication of reference signals, latency may be crucial. For instance, a certain number of reference signal occasions may be required to obtain successful operation, e.g. so as to convey sufficient energy or carry out a required number of successive measurements. In some scenarios, fitting a required number of reference signal occasions into a preconfigured BWP may be challenging, such as when the BWP is comparatively narrow and/or when the resources of that BWP are occupied to a large extent for other communication signaling purposes. As a result, latency may occur.

Within the field of positioning, i.e. determining a location of the UE, reference signal communication may be used in UL and/or DL. In this context, enhancements have been discussed for latency reductions. A suggested solution for reducing latency that has been discussed is to utilize preconfigured measurement gaps (MG) with lower latency to perform the transmission of the positioning signals. The MG will occur in the preconfigured used BWP, and may free up resources for use by positioning signals, for the purpose of accomplishing a required number of reference signal occasions in a shorter time span.

There nevertheless exists a need for improved or alternative methods for tackling the issue of latency in reference signal communication.

### SUMMARY

In view of the foregoing, solutions are presented herein for improving communication of reference signals where such reference signals are required for latency sensitive operations. The invention targets this objective and is defined by the independent claims, whereas various further advantageous features are set out in the dependent claims.

### BRIEF DESCRIPTION OF THE DRAWINGS

FIG. 1 schematically illustrates an implementation of a wireless communication system, in which a UE communicates with a network node, such as an access node of wireless network.

FIG. 2 schematically illustrates a UE configured to communicate with the wireless network according to various examples.

FIG. 3 schematically illustrates an access node of the wireless network according to various examples.

FIG. 4 illustrates different steps which may be included in various examples of the proposed solution in a method carried out in a network node.

FIG. 5 illustrates different steps which may be included in various examples of the proposed solution in a method carried out in a UE.

FIG. 6 illustrates a diagram of a schematic representation of resources in different BWPs, with BWP switching to communicate reference signals, according to various examples.

FIG. 7 schematically illustrates a signaling diagram in which a UE is configured with resource allocation information by a wireless network for operation in accordance with various examples.

FIG. 8 schematically illustrates a signaling diagram in which a UE is controlled to switch BWP for communication of reference signals in accordance with various examples.

FIG. 9 illustrates a diagram of a schematic representation of resources in different BWPs, with BWP switching to communicate reference signals, according to various examples.

### DETAILED DESCRIPTION

In the following description, for purposes of explanation and not limitation, details are set forth herein related to various embodiments. However, it will be apparent to those skilled in the art that the present invention may be practiced in other embodiments that depart from these specific details. In some instances, detailed descriptions of well-known devices, circuits, and methods are omitted so as not to obscure the description of the present invention with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof. The terms “receive” or “receiving” data or information shall be understood as “detecting, from a received signal”.

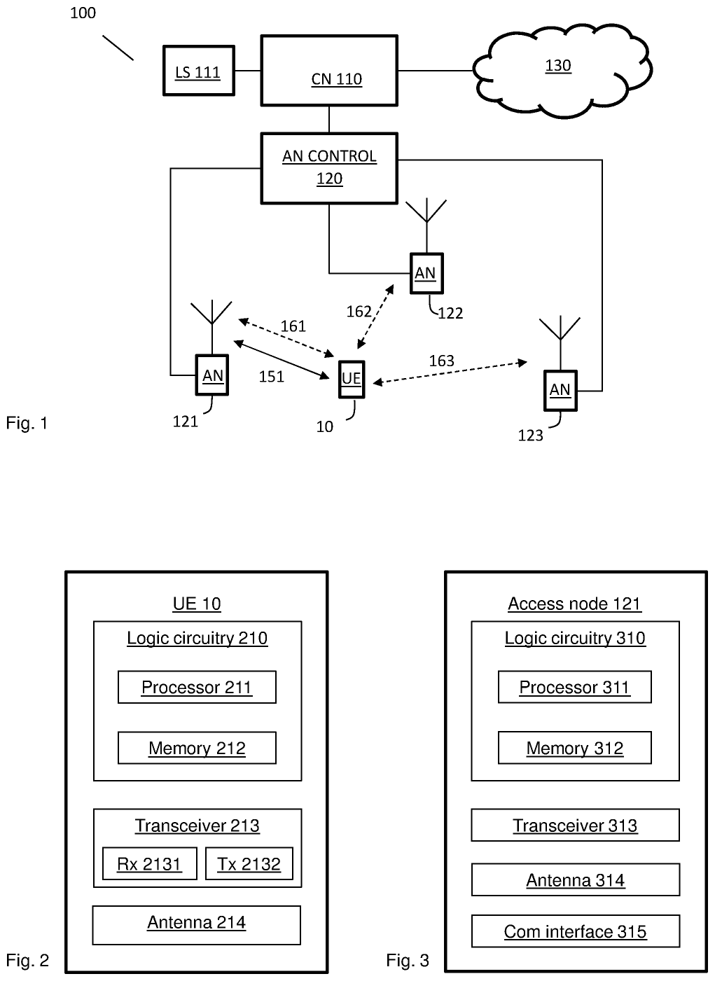

FIG. 1 illustrates a high-level perspective of operation of a UE 10 in a wireless network 100. The wireless network 100 may be a radio communication network 100, configured to operate under the provisions of 5G NR as specified by 3GPP, according to various embodiments outlined herein. The wireless network 100 may comprise a core network (CN) 110, which in turn may comprise a plurality of core network nodes. The core network 110 may comprise, or be connected to, a location server 111.

The core network is connected to at least one access network comprising one or more base stations or access nodes (AN), of which one access nodes 121, 122 and 123 are illustrated. Reference will predominantly be made to access node 121 herein, whereas access nodes 122 and 123 may comprise corresponding features and functions. The access node 121 is a radio node configured for wireless communication on a physical channel 151 with various UEs, of which only the UE 10 is shown. The core network 110 may in turn be connected to other networks 130. An access node control entity 120 is further shown, which may comprise a node or logical function which communicatively interconnects at least the access nodes 121-123 within the access network.

Before discussing further details and aspects of the proposed method, functional elements for the UE 10 and the access node 121, configured to carry out various tasks according to the proposed solution, will be briefly discussed.

FIG. 2 schematically illustrates an example of the UE 10 for use in a wireless network 100 as presented herein, and for carrying out various method steps as outlined.

The UE 10 comprises a radio transceiver 213 for communicating with other entities of the radio communication network 100, such as the access node 121, in different frequency bands. The transceiver 213 may thus include a receiver chain (Rx) 2131 and a transmitter chain (Tx) 2132, for communicating through at least an air interface.

The UE 10 may further comprise an antenna system 214, which may include one or more antennas, antenna ports or antenna arrays. In various examples the UE 10 is configured to operate with a single beam, wherein the antenna system 214 is configured to provide an isotropic sensitivity to transmit radio signals. In other examples, the antenna system 214 may comprise a plurality of antennas for operation of different beams in transmission and/or reception. The antenna system 214 may comprise different antenna ports, to which the Rx 2131 and the Tx 2132, respectively, may selectively be connected. For this purpose, the antenna system 214 may comprise an antenna switch.

The UE 10 further comprises logic circuitry 210 configured to communicate data and control signals, via the radio transceiver, on a physical channel 151 to a serving access node 121 of the wireless communication network 100. The logic circuitry 210 may further be configured to communicate reference signals 161, 162, 163 with a plurality of access nodes 121-123 of the wireless communication network 100.

The logic circuitry 210 may include a processing device 211, including one or multiple processors, microprocessors, data processors, co-processors, and/or some other type of component that interprets and/or executes instructions and/or data. The processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic circuitry 210 may further include memory storage 212, which may include one or multiple memories and/or one or multiple other types of storage mediums. For example, the memory storage 212 may include a random access memory (RAM), a dynamic random access memory (DRAM), a cache, a read only memory (ROM), a programmable read only memory (PROM), flash memory, and/or some other type of memory. The memory storage 212 may include a hard disk (e.g., a magnetic disk, an optical disk, a magneto-optic disk, a solid state disk, etc.). The memory storage 212 is configured for holding computer program code, which may be executed by the processing device 211, wherein the logic circuitry 210 is configured to control the UE 10 to carry out any of the method steps as provided herein. Software defined by said computer program code may include an application or a program that provides a function and/or a process. The software may include device firmware, an operating system (OS), or a variety of applications that may execute in the logic circuitry 210.

Obviously, the UE 10 may include other features and elements than those shown in the drawing or described herein, such as a power supply, a casing, a user interface, sensors, etc., but these are left out for the sake of simplicity.

FIG. 3 schematically illustrates a radio node in the form of an access node 121 of the wireless network 100 as presented herein, and for carrying out the method steps as outlined. In various examples, the access node 121 is a radio base station for operation in the radio communication network 100, to serve one or more radio UEs, such as the UE 10.

The access node 121 may comprise a wireless transceiver 313, such as a radio transceiver for communicating with other entities of the radio communication network 100, such as the terminal 10. The transceiver 313 may thus include a radio receiver and transmitter for communicating through at least an air interface.

The access node 121 further comprises logic circuitry 310 configured to control the access node 121 to communicate with the UE 10 via the radio transceiver 313 on a physical channel 151.

The logic circuitry 310 may include a processing device 311, including one or multiple processors, microprocessors, data processors, co-processors, and/or some other type of component that interprets and/or executes instructions and/or data. Processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic circuitry 310 may further include memory storage 312, which may include one or multiple memories and/or one or multiple other types of storage mediums. For example, memory storage 312 may include a random access memory (RAM), a dynamic random access memory (DRAM), a cache, a read only memory (ROM), a programmable read only memory (PROM), flash memory, and/or some other type of memory. Memory storage 312 may include a hard disk (e.g., a magnetic disk, an optical disk, a magneto-optic disk, a solid state disk, etc.).

The memory storage 312 is configured for holding computer program code, which may be executed by the processing device 311, wherein the logic 310 is configured to control the access node 121 to carry out any of the method steps as provided herein. Software defined by said computer program code may include an application or a program that provides a function and/or a process. The software may include device firmware, an operating system (OS), or a variety of applications that may execute in the logic 310.

The access node 121 may further comprise, or be connected to, an antenna 314, which may include an antenna array. The logic 310 may further be configured to control the radio transceiver to employ an anisotropic sensitivity profile of the antenna array to transmit radio signals in a particular transmit direction. The access node 121 may further comprise an interface 315, configured for communication with the core network 110 and/or with other access nodes 122, 123. Obviously, the access node 121 may include other features and elements than those shown in the drawing or described herein, such as a power supply and a casing etc.

As is well established in different releases of 3GPP specifications, positioning of a UE may be employed using a radio access technology (RAT) method, i.e. based on reference signals communicated in the wireless system between a UE 10 and a plurality of access nodes 121-123. Such positioning may be based on reference signals 161-163 transmitted in the UL by the UE 10, wherein such reference signals are received and measured in a plurality of access nodes 121-123. These reference signals 161-163 may e.g. be so-called sounding reference signals (SRS). Alternatively, a plurality of access nodes 121-123 may be configured to transmit reference signals in the DL, for reception and measurement in the UE 10. An example of such reference signals are so-called positioning reference signals (PRS). The UE 10 may be configured to report its measurement results to the wireless network, and for instance the location server 111 may be arranged to determine the location of the UE 10 based on calculations carried out on the measurement results. Alternatively, the UE 10 may itself be configured to make such calculations to determine its location.

As noted, in discussions related to latency reductions for positioning, one considered option is to utilize measurement gaps (MG) with lower latency to perform the transmission of the positioning signals (PRS in DL/SRS in UL). A reason for using MG is that PRS bandwidth (BW) is not always within the UE DL BWP. This scenario may become even more common if networks start employing narrow BWP sizes for power consumption reasons, e.g. for reduced capability (RedCap) devices or power sensitive devices. The MG may provide sufficient time for the UE to read PRSs over the wider BW which networks aim to use in many cases for PRS transmission due to more precise estimate of UE location.

If networks are in control of how the PRSs are transmitted for several surrounding transmission and reception points (TRPs), related to various access nodes, it might be possible to measure PRS without the scheduled MG. However, the UE is configured to operate within its allocated BWP and not outside of it. In 3GPP release 15, four different BWPs are defined: Initial BWP, First Active BWP, Default BWP and regular/normal BWP. They are configured by radio resource control (RRC) messages. It is possible to define four different regular BWPs for each of UL and DL. Both for DL and UL BWP, downlink control indicator (DCI) message may be used to switch between them. Nevertheless, only one active BWP is allowed and supported out of the four regular BWPs possible to configure simultaneously. A switch of BWP will consume time impacting the reception/transmission of reference signals, and the BWP switching delays are defined in 38.133 Table 8.6.2-1 (rel 16) as outlined below.

TABLE 8.2.1.2.7-1
interruption length X

| | NR Slot | Interruption length X |
|---|---|---|
| μ | length (ms) | (slots) |
| 0 | 1 | 1 |
| 1 | 0.5 | 1 |
| 2 | 0.25 | 3 |
| 3 | 0.125 | 5 |

Note1:
void

A breakdown of the “interruption length X” from the table above consist of Rx delay, DCI decoding, L1 processing and RF retuning. Some of the delay time is implementation dependent, e.g. buffering, delays in the data path, DCI decoder implementation, and phase locked loop (PLL) re-lock speed of a local oscillator (LO), automatic gain control (AGC) and automatic frequency control (AFC) settling, and Rx Filter stabilization. Some is also related to the specification or more how the allocation of resources is made e.g. if BW only changes, only the carrier frequency or both. Also, if both BWP is within maximum UE BW and covered by current carrier frequency setting. Additionally, smaller steps in carrier frequency may take less time than larger steps. Another thing that is faster is if only the numerology of the BWP changes. Also, less decoding candidates of the DCI would affect the delay.

The solutions proposed herein describe how to reduce latency for operations which rely on communication of reference signals between the UE 10 and the wireless network 100, by proposing a way to retune the UE 10 and switch to a different BWP in which reference signals are allocated in a faster way. The proposed solutions will primarily be described in the context of positioning, in which reference signals are transmitted, received, and measured, for determining a location of the UE 10. Other types of operations or applications, relying on the measurement or detection of reference signals, are plausible too. Within the context of positioning, an example of the proposed solution is gapless PRS reception in the UE 10 of PRS transmitted from a plurality of access nodes, such as from a restricted number of TRPs. Positioning with gapless PRS measurement is mostly relevant when TRPs are controlled by the same entity, such as access node control entity 120, and share the knowledge of its PRS scheduled resources, such as in a private network or non-public network.

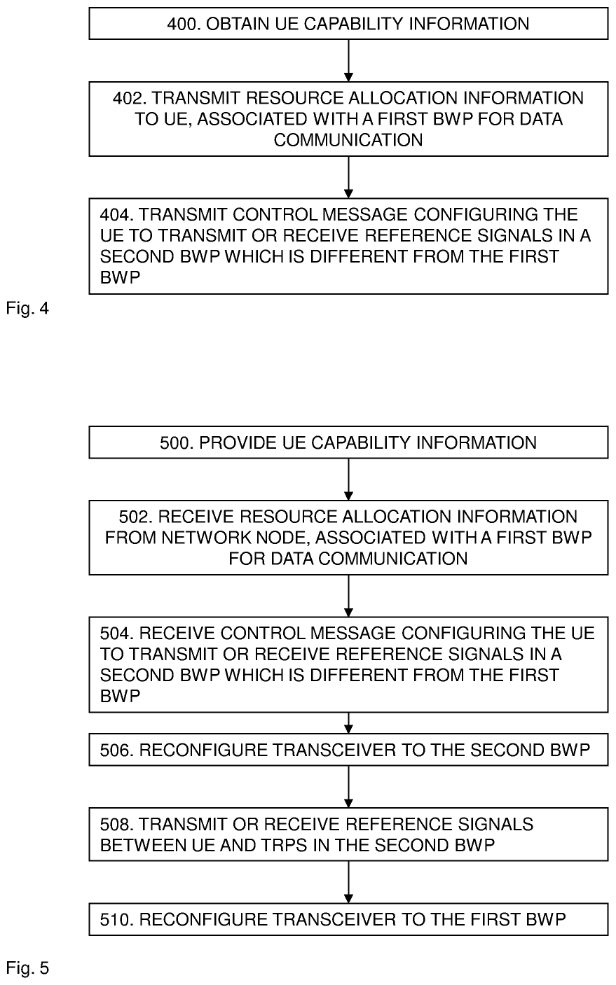

Reference is now made to FIG. 4, which shows various steps that may be comprised in a method carried out in the wireless network 100, which comprises access nodes, for configuring the UE 10 for communication of reference signals 161, 162, 163 between the UE 10 and the wireless network 100, the method comprising:
transmitting 402 resource allocation information to the UE, associated with a first BWP for data communication 151, referred to herein as aBWP-active BWP;
transmitting 404, in resources of aBWP, a control message controlling the UE 10 to transmit and/or receive said reference signals in a configured second BWP, herein referred to as pBWP, wherein the second BWP, pBWP, is different from the first BWP, aBWP.

The method may be carried out in an access node 121, or e.g. be operated in distributed network nodes including the access node 121 and the location server 111.

In FIG. 5, various steps are shown that may be comprised in a method carried out in the UE 10 for obtaining configuration for communication of reference signals 161,162,163 between the UE and access nodes of the wireless network 100, the method comprising:
receiving 502 resource allocation information from a network node of the wireless network, associated with a first bandwidth part aBWP for data communication;
receiving 504, in resources of aBWP, a control message controlling the UE to transmit and/or receive said reference signals in pBWP, wherein the pBWP is different from aBWP.

The proposed solution allows for the network 100 to control the UE 10 to reconfigure its transceiver to resources of a dedicated pBWP (such as a dedicated positioning BWP) containing reference signal resources, e.g. PRS or SRS, with a shorter delay (time of no reception/transmission) between reference signal occasions. The pBWP may be wider bandwidth or just be a BWP where the reference signal resources are located closer in time. By allocation of more reference signal resources elements per time slot in the pBWP, the time utilized for completing an operation relying on the reception of such reference signals, such as achieving a certain positioning accuracy, may be reduced resulting in lower latency.

In various examples, the proposed solution involves UE communicating its switching performance for BWP configuration/reconfiguration, allowing for a faster retune and shorter interruption lengths. This may thus involve the UE providing 500 capability information, which is obtained 400 in the access network 100. In this context, it may be pointed out that UE capability information may be conveyed by the UE either explicitly, or by means of indicating capabilities which are prestored in the wireless network 100. The switching performance may include or indicate a switch delay T_{S}, representing a switch delay required for the UE 10 to switch from one BWP to another BWP. The switch delay may be dependent on e.g. a PLL circuit performance in the UE 10. The switching performance may be specified with respect to switching between specific BWPs, such as aBWP and pBWP, or a nominal minimum value for BWP switching. Based on the conveyed switching performance, the wireless network 100 knows when, e.g. in what symbol, it is relevant to schedule the first of the reference signal symbols for the pBWP. Communication of the switching delay or interruption length can be provided by an indicator directly associated with a measure in time, such a number of ms, slots, symbols or other. As an alternative, groups of times (association of pBWP to a current aBWP) can be defined, and the UE 10 may be arranged to communicate to which the group it belongs. In such embodiments, the switching delay can be conveyed by reporting the associated group belonging, such as a group ID. As an example, Interruption length groups may be defined as in Table 1 below, per configured BWP.

TABLE 1
Example of update interruption length table for BWP switching. Each
length represents a BWP interruption group. The UE 10 may report,
applicable for each configured pBWP, to which BWP interruption
group switching among the configured BWPs belongs.

| | Short | Middle | |
|---|---|---|---|
| | Interruption | Interruption | Long Interruption |
| μ | length | Length | Length |
| 0 | 1 symbol | 4 symbols | 1 slot |
| 1 | 1 symbol | 4 symbols | 1 slot |
| 2 | 1 symbol | 14 symbols | 3 slots |
| 3 | 1 symbol | 21 symbols | 5 slots |

In accordance with various examples of the proposed solution, the control message transmitted from the wireless network 100 to the UE 10 controls the UE 10 to temporarily switch from the aBWP to the pBWP to communicate said reference signals. In response to receiving the control message, the UE 10 may thus be controlled to temporarily reconfigure 506 its transceiver 213 to communicate 508 reference signals in reference signal resources within the pBWP, i.e. to either transmit or receive reference signal dependent on UL or DL operation, and subsequently reconfigure 510 the transceiver 213 back to operation within the aBWP.

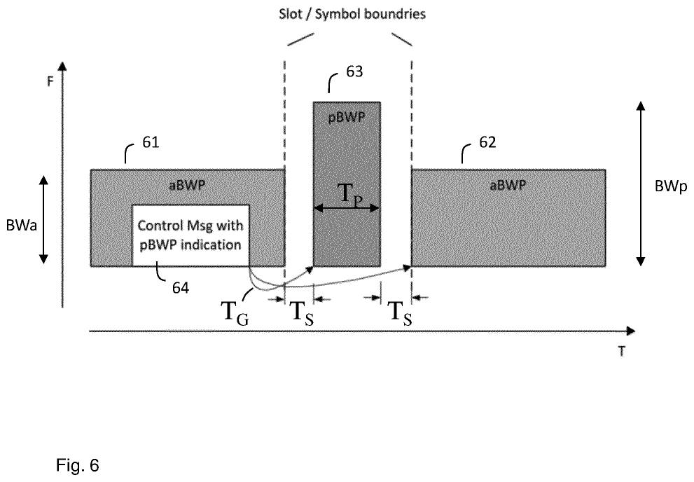

Further aspects and detail of different examples of the proposed solutions will be outlined below with reference to FIGS. 6-9. The disclosure will be related to configuration for communication of reference signals for the purpose of obtaining location of the UE 10, and the reference signals will therefore occasionally be referred to as positioning signals.

FIG. 6 schematically illustrates a time (T) frequency (F) diagram, comprising slots 61, 62 of the aBWP, within a bandwidth BWa, and a slot 63 of the pBWP, within a bandwidth BWp. The drawing illustrates resource allocation configuration of the control message 64 in the aBWP. The control message 64 controls the UE 10 to reconfigure for reception of reference signals in the pBWP 63. Upon reconfiguration of the UE 10 to the pBWP, the UE 10 may communicate positioning signals with more resource elements per time unit, e.g. in a wider bandwidth BWp in the example of FIG. 6. The aBWP may be used for any legacy operation including positioning. T_{S} is the switch time between the different BWPs.

As is schematically indicated by the curved arrows in FIG. 6, the control message 64 may indicate timing information of reference signal resources within the pBWP 63. In this context, the control message may indicate a time window T_{P} for communicating reference signals within the pBWP, such as a starting point and a length of the time window or of an endpoint of the time window. The timing information may, in addition to indicating a starting point of the time window T_{P}, further indicate (directly or indirectly) a subsequent slot or symbol boundary when the UE 10 is to reconfigure its transceiver 213 for communication in the aBWP 62 after said time window. The starting point of the time window T_{P} for use by the UE 10 may be configured to be at least the known time delay T_{S}, e.g. counted from a slot or symbol boundary of the aBWP 61. A corresponding delay is configured after the T_{P} to the boundary where the UE 10 is to be ready to operate on the aBWP 62. The control message is transmitted by the network 100 such that a time gap TG, preceding the configured start of the reference signal resources in the pBWP, which time gap is scheduled based on, and at least exceeds, the switching time T_{S}. In one example, the timing information may define an end position of the time window indirectly, as a time when sufficient reference signal communication has been obtained, such as when PRS have been detected and measured to obtain a measurement value fulfilling a certain measurement criteria, predefined or indicated in the control message 64, such as meeting a threshold criteria. The measurement criteria may relate to one or more of signal magnitude measurement values, and/or time or arrival measurement values, and/or angle of arrival measurement values, as obtained from a plurality of access nodes 121-123.

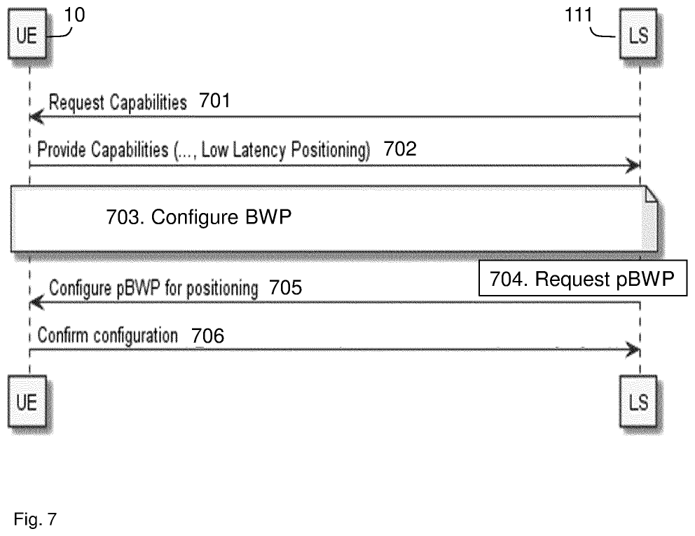

FIG. 7 schematically illustrates a signaling diagram, in which one example of a configuration of the UE 10 is shown, i.e. the conveyance of resource allocation information from the wireless network 100 to the UE 10. The drawing indicates one example of how the wireless network, such as the location server 111, obtains 702 capability information associated with low latency positioning, e.g. in response to a capability request 701. In step 703 the UE 10 may be configured to obtain resource allocation information associated with at least the aBWP for data communication. Configuration of the pBWP may be carried out at the same time, or in conjunction with, the configuration of the aBWP in step 703. The configuration of pBWP may, in some examples, be based on a location request 704 by the location server 111, wherein configuration of the pBWP is requested from the access network. In some examples, the method may comprise transmitting 705 configuration information from the wireless network 100 identifying resource allocation information for the pBWP. This message 705 may originate from the location server 111 or alternatively from a serving access node 121. The UE 10 may be configured to confirm 706 the configuration. The confirmation 706 may comprise an indication of the switching time T_{S} associated with the identified pBWP indicated in the message 705, or of a group identification related to a BWP interruption length group, as defined by the wireless network 100 or by specification, as described in association with Table 1.

According to some examples of the proposed solution, the BWP switching for communication of reference signals is triggered from a location request using LPP (LTE Positioning Protocol) communication, wherein the control message 64 may be an LPP message. Additionally, or alternatively, the control message 64 may originate from the serving access node 121, by MAC-CE or DCI based triggering. Nevertheless, regardless of the originating entity within the wireless network 100, when the control message 64 with an indicator is transmitted to the UE 10, the UE 10 may rapidly switch from the aBWP to the pBWP, as indicated in FIG. 6. As noted, there will be one switch delay when moving from aBWP→pBWP but also one when moving from pBWP→aBWP. To optimize the signaling it is proposed one control message 64 indicates both switching occasions. The control message can indicate start and stop of pBWP according to a pattern (e.g. certain symbols and slots according to a communicated description) or just by a start and stop time etc. associated with T_{P}, maintaining the scheduling entities of slots and mini slots of NR. In legacy 3GPP specifications, PRS signals are transmitted in PRS occasions (in the same BWP) where the start and number of slots (duration) of the PRS occasion is indicated. In some examples of the proposed solution, a similar concept and wording can be utilized in the pBWP, wherein the control message 64 indicates the timing information as start and number of slots (duration) of the PRS occasions.

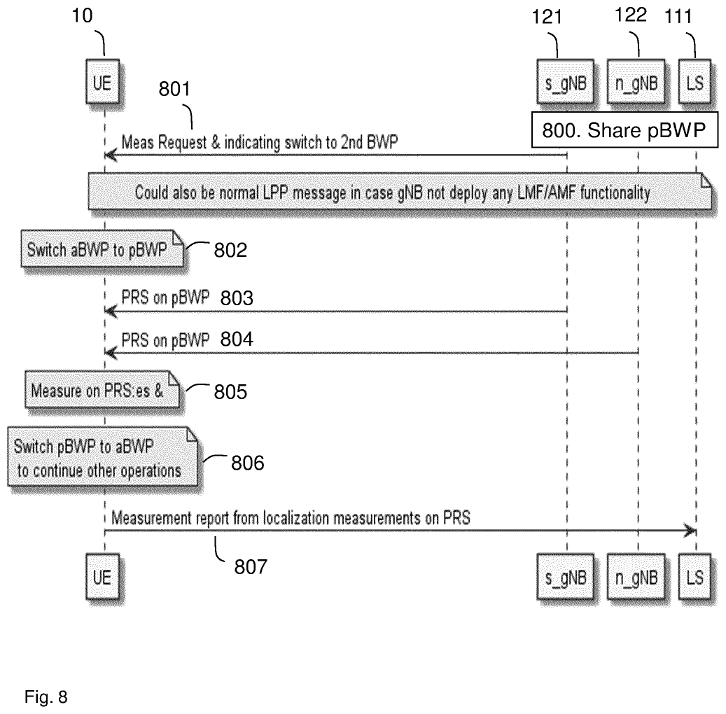

FIG. 8 shows a signaling diagram of switching BWP according to various examples of the proposed solution. The configuration of the aBWP and the pBWP may have been obtained using the features outlined with reference to FIG. 7. This example is provided for DL positioning, wherein the UE 10 is controlled to obtain PRS from a plurality of access nodes 121-123.

Signaling step 801 involves the transmission of the control message 64 on the aBWP, which message 64 controls the UE 10 to switch from the aBWP to the pBWP. As mentioned, and indicated, this message 64 may be transmitted 801 from the location server 111 or from the serving access node 121.

The UE 10 is thus controlled to switch 802 to the pBWP by reconfiguring its transceiver 213. Subsequently, the UE receives 803, 804 PRS from a plurality of access nodes, e.g. including the serving access node 121 and neighboring access nodes 121, 123. The UE makes measurements 805 based on the received PRS to obtain e.g. signal magnitude measurement values and/or time or arrival measurement values, and/or angle of arrival measurement values.

The UE 10 subsequently switches 806 back to the aBWP. Timing information for switching back may have been provided in the control message signaled at 801, as explained above. The UE 10 then reports 807 obtained measurement values. It will be understood that in an example where the UE 10 is configured to not only measure PRS, but also to determine a location based on the measurements 805, such location may be reported in the signaling 807.

In accordance with various examples of the proposed solution, a network node, such as the serving access node 121 or the location server 111, may be configured to transmit 800, to further access nodes 122,123 of said plurality of access nodes, resource allocation information for said reference signals in the second BWP. This way, the wireless network is arranged to ensure that involved access nodes 121-123 will employ the same pBWP during the communication of reference signals, such as for transmitting PRS, with respect to the timing information conveyed to the UE 10.

The wireless network 100 will attempt to utilize its system resources efficiently scheduling resources over its system bandwidth. Using BWPs will, like described in the background, allow for a better UE power consumption. To know how to place the PRS resources and utilize the invention the network may categorize UEs into BWP groups based on feedback from the registered UEs operating in the closest location area, i.e. at least cells and beams the UE can reach. The wireless network 100 may build this database or learn and maintain a dynamic model (e.g. AI based) of the UEs operating in the network. This model or database can be input to how the BWPs (in particular the pBWP) and resource allocation are configured given the geographical area with its cell and beam deployment.

For one configured active BWP (aBWP) there may be several options to configure the secondary BWP (pBWP) intended for low-latency positioning. The first most likely best option is to utilize a pBWP close to the active BWP or containing the active BWP but wider, as indicated in FIG. 6. If the UE are close to TRPs (e.g. smaller cells) even a change in numerology may be one of the first options to squeeze in more resources than what is possible in the aBWP. A second option could be BWPs with a smaller frequency offset from the active BWP and a third option could be a BWP with longer switching times. Within each group a certain relock time is guaranteed and communicated. Parts of this logic are legacy procedures available in networks but which need to be extended to cover pBWP and the grouping into switching delays/interruption length (T_{S}) groups described here for an efficient pBWP handling. In some examples, the control message is configured to identify the UE 10 by indicating a UE group to which group said UE 10 belongs, which UE group is defined by a BWP switching time criterion. This is based on the idea of sorting UEs with respect to its switching time T_{S} and possibly with respect to its current aBWP. In order to meet a latency requirement in e.g. positioning, the UE 10 may be identified with a group belonging, e.g. by means of a group ID, which directs it to pBWP configured relative to the aBWP, such that the latency requirement may be met.

As described in the background section, in legacy procedures, one option for BWP switching of the regular BWPs is to use a control message indicating use of a BWP preconfigured by RRC message. As an alternative, a special positioning RNTI containing a DCI indicating the BWP setup including details for the pBWP is used. This way, RRC doesn't have to be involved for switching to a BWP not preconfigured by RRC messages. In this context, the control message comprises a downlink control indicator (DCI) indicating BWP setup for the pBWP. With this arrangement, a potential saving for BWP switching compared to RRC reconfiguration is in the range of 5-80 ms. One field of application for this example may be for low latency positioning in RRC IDLE or RRC INACTIVE mode. A UE wanting to position itself could read a beam/cell specific positioning RNTI encoded DCI, get redirected to the BWP with PRSs and get back into its sleep state in a faster way.

As a potential restriction, only UEs with latency critical capability configured may be allowed to have the option to be configured with pBWP for low latency. Thereby a UE may be categorized, by default or by an entity of the wireless network, e.g. the location server 111, into positioning latency critical UEs and non latency critical UEs. This categorization may utilize information of different switching delays T_{S} and favoring the UEs with low-latency demands to be redirected to pBWP. This means that the amount of UEs to schedule for redirection could be minimized to the UEs with tougher latency requirements in combination with the UEs capable of benefiting from such a redirection. In this context, the control message is configured to identify the UE responsive to capability information of the UE meeting a predetermined latency-sensitivity criterion.

Returning to FIG. 6, in some examples the pBWP has a wider bandwidth allocation BWp than the bandwidth allocation BWa of the aBWP. This facilitates accomplishing sufficient reference signal communication in a comparatively short time, as opposed to communicating reference signals in the aBWP. The pBWP may overlap the aBWP in frequency. Specifically, in some examples (contrary to the example of FIG. 6) the first aBWP and the pWP have a common center frequency. This may shorten the switching time required by the UE 10, as opposed to changing center frequency.

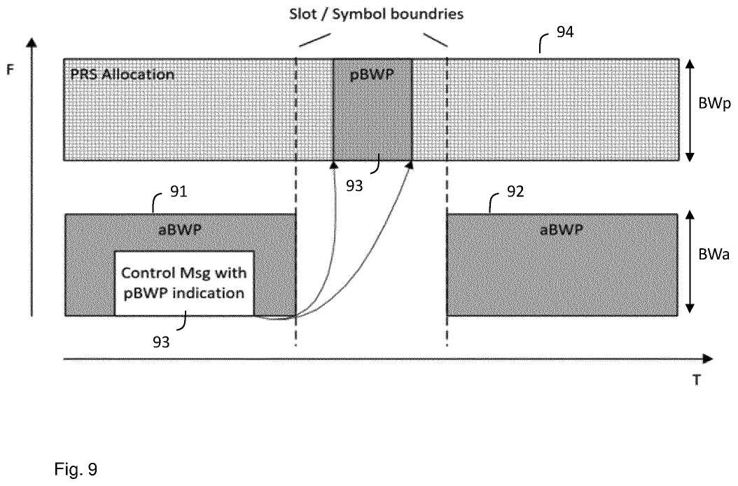

FIG. 9 illustrates an example which is an alternative to the examples described with reference to FIG. 6. Here, the pBWP is scheduled in a more dedicated part of the system BW for the wireless network, and used specifically for positioning. This kind of deployment could for example be considered in factory setups or private networks with requirements on lower latency. Additionally, the method is applicable for use in scenarios of Reduced Capability devices (RedCap). Since RedCap operates on UE bandwidth smaller than typical NR legacy it cannot utilize the full system bandwidth for PRS reception. Rather than allocation of reference signal occasions being extended in time, causing long measurement gaps for PRS or extended PRS allocation in a gapless allocation, it is proposed to allocate the PRS on a different pBWP 94. This way, switching to the pBWP for positioning enables faster reception of the PRSs compared to waiting for measurement gaps, and PRS occasion may be reduced compared always allocating PRS resources in the aBWP 91, 92. Configuration of the control message 93 may be accomplished in accordance with any of the variants explained above with reference to control message 64.

In a similar way as for BWPs, the method may be extended utilizing component carriers (CC). Component carriers contain BWPs and a PRS may be indicated in a BWP that is located in a different CC. The concept as for BWP switching will be the same, but the switching time may be a little longer for non-contiguous carriers.

Various features and examples related to the proposed solutions have been outlined above. The proposed solution relates to BWP switching for the purpose of temporary configuration to communicate reference signals, such as positioning signals, in particular to counteract latency issues related to operations relying on such reference signals. Various features may further be employed which take UE capability and/or reporting into account to provide for convenient setup of the control message triggering the BWP switch. The proposed solution may be arranged in accordance with foregoing, and as outlined in the following claims.

1. A method, carried out in a wireless network comprising access nodes, for configuring a user equipment (UE), for communication of reference signals between the UE and the wireless network, the method comprising:
transmitting resource allocation information to the UE, associated with a first bandwidth part (BWP), for data communication;
transmitting, in resources of the first BWP, a control message controlling the UE to transmit and/or receive said reference signals in a configured second BWP,
wherein the second BWP is different from the first BWP.

2. The method of claim 1, wherein said control message controls the UE to temporarily switch from the first BWP to the second BWP to transmit or receive said reference signals.

3. The method of claim 1, wherein said control message indicates timing information of reference signal resources within the second BWP.

4. The method of claim 3, wherein said timing information comprises a time window for communicating said reference signals within the second BWP.

5. The method of claim 3, comprising:
obtaining capability information associated with BWP switching time of the UE;
wherein the control message is configured based on said BWP switching time.

6. The method of claim 5, wherein said timing information identifies a time gap from the transmission of the control message, which time gap is scheduled based on said BWP switching time.

7. The method of claim 1, wherein said resource allocation information identifies the second BWP.

8. The method of claim 1, wherein said control message identifies the second BWP.

9. The method of claim 1, wherein the second BWP has a wider bandwidth allocation than the first BWP.

10. The method of claim 1, wherein the second BWP overlaps the first BWP in frequency.

11. The method of claim 1, wherein the first BWP and the second BWP have a common center frequency.

12. The method of claim 1, wherein the second BWP is allocated outside a frequency range of the first BWP.

13. The method of claim 1, wherein the second BWP has higher numerology than the first BWP.

14. The method of claim 1, wherein the control message identifies the UE.

15. The method of claim 1, wherein the control message identifies the UE by indicating a UE group to which group said UE belongs, which UE group is defined by a BWP switching time criterion.

16. The method of claim 14, wherein the control message is configured to identify the UE responsive to capability information of the UE meeting a predetermined latency-sensitivity criterion.

17. The method of claim 1, wherein said reference signals are positioning reference signals, wherein the UE is configured for communication of said reference signals between the UE and a plurality of said access nodes.

18. The method of claim 17, wherein the UE is configured to receive said reference signals transmitted from said plurality of access nodes.

19. The method of claim 17, wherein the UE is configured to transmit said reference signals for reception in said plurality of access nodes.

20-22. (canceled)

23. A method, carried out in a user equipment (UE) for obtaining configuration for communication of reference signals between the UE and access nodes of a wireless network, the method comprising:
receiving resource allocation information from a network node of the wireless network, associated with a first bandwidth part (BWP), for data communication;
receiving, in resources of the first BWP, a control message controlling the UE to transmit and/or receive said reference signals in a configured second BWP,
wherein the second BWP is different from the first BWP.

24-33. (canceled)
